(19) United States
(12) Patent Application Publication
(10) Pub. No.: US 2005/0024550 A1
(43) Pub. Date: Feb. 3, 2005

(54) Thin film transistor array panel and manufacturing method thereof

(75) Inventor: Dong-Gyu Kim, Yongin-si (KR)

Correspondence Address: David W. Heid;MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 10/903,794

(22) Filed: Jul. 29, 2004

(30) Foreign Application Priority Data
Jul. 29, 2003 (KR) 2003-52253

(51) Int. Cl. G02F 1/136

(52) U.S. Cl. 349/43

(57) ABSTRACT

Thin film transistor array panels for liquid crystal displays and methods for manufacturing the same are provided. In one embodiment, a thin film transistor array panel includes an insulating substrate, a conductive layer, a passivation layer including a passivation layer aperture, a color filter including a color filter aperture, and a pixel electrode operably coupled to the conductive layer via the color filter aperture and the passivation layer aperture. The disclosed structures and methods advantageously provide for enhanced connections and lowered contact resistance.

### BACKGROUND

(a) Field of the Invention

The present invention relates to a thin film transistor array panel and a manufacturing method thereof.

(b) Description of Related Art

Liquid crystal displays (LCDs) are one of the most widely used flat panel displays. An LCD includes two panels having field-generating electrodes with a gap interposed therebetween, and a liquid crystal (LC) layer filling the gap between the panels. The LCD displays images by applying voltages to the field-generating electrodes to generate an electric field in the LC layer, which determines orientations of LC molecules in the LC layer to adjust polarization of incident light.

The LCD includes a plurality of pixels arranged in a matrix and a plurality of signal lines for driving the pixels such as gate lines for transmitting scanning signals and data lines for transmitting data signals. Each pixel includes a pixel electrode, a color filter, and a thin film transistor (TFT) connected to the gate lines and the data lines for controlling the data signals.

Typically, one of the panels of the LCD, called a TFT array panel, includes the gate lines, the data lines, the pixel electrodes, and the TFTs and the other of the two panels includes the color filters for color representation.

It has been suggested that the color filters may be placed on the TFT array panel for obtaining large aperture ratio by decreasing the alignment error range between the panels. For example, the color filters are disposed under the pixel electrodes and they have contact holes for connecting the pixel electrodes to the TFTs. However, such a contact structure disadvantageously causes disconnection of overlying layers and increases contact resistance.

Such a poor contact structure may be improved using additional photo-etching steps, but this makes the manufacturing process complicated and increases the production cost.

### SUMMARY

The present invention provides novel and advantageous TFT array panels for an LCD and methods for manufacturing the same. The disclosed structures and methods advantageously provide for enhanced connections and lowered contact resistance.

According to one embodiment of the present invention, a thin film transistor array panel is provided, comprising an insulating substrate; a conductive layer over the insulating substrate; a first passivation layer over the conductive layer; a color filter over the first passivation layer, the color filter including a color filter aperture; a second passivation layer over the color filter and filling the color filter aperture; and a pixel electrode over the second passivation layer, the pixel electrode being operably coupled to the conductive layer via an aperture through the second passivation layer and the first passivation layer, the aperture being aligned with the color filter aperture.

According to another embodiment of the present invention, a thin film transistor array panel comprises an insulating substrate; and a stack with a common etched edge over the insulating substrate, the stack including a semiconductor stripe, an ohmic contact over the semiconductor stripe, and a drain electrode of a transistor over the ohmic contact. The panel further comprises a passivation layer over the stack, the passivation layer having a passivation layer aperture over the stack; a color filter over the passivation layer, the color filter having a color filter aperture over the stack; and a pixel electrode over the color filter, the pixel electrode operably coupled to the drain electrode via the color filter aperture and the passivation layer aperture.

According to yet another embodiment of the present invention, a method of manufacturing a thin film transistor array panel is provided, the method comprising providing an insulating substrate; forming a conductive layer over the insulating substrate; forming a first passivation layer over the conductive layer; forming a color filter over the first passivation layer; etching a color filter aperture through the color filter and over the conductive layer; forming a second passivation layer over the color filter and filling the color filter aperture; etching an aperture through the first and second passivation layers, the aperture being aligned with the color filter aperture; and operably coupling a pixel electrode to the conductive layer via the aperture through the first and second passivation layers.

According to yet another embodiment of the present invention, another method of manufacturing a thin film transistor array panel comprises providing an insulating substrate; and forming a stack with a common etched edge over the insulating substrate, the stack including a semiconductor stripe, an ohmic contact over the semiconductor stripe, and a drain electrode of a transistor over the ohmic contact. The method further comprises forming a passivation layer over the stack; forming a color filter over the passivation layer; etching a color filter aperture over the stack; etching a passivation layer aperture over the stack; and operably coupling a pixel electrode to the drain electrode via the color filter aperture and the passivation layer aperture.

### BRIEF DESCRIPTION OF THE DRAWINGS

The present invention will become more apparent by describing embodiments thereof in detail with reference to the accompanying drawings in which:

FIG. 1 is a layout view of a TFT array panel for an LCD according to an embodiment of the present invention;

FIG. 2 is a sectional view of the TFT array panel shown in FIG. 1 taken along the line II-II′;

FIGS. 3A, 4A, 5A, 6A, and 7A are layout views of the TFT array panel shown in FIGS. 1 and 2 in intermediate steps of a manufacturing method thereof according to an embodiment of the present invention;

FIGS. 3B, 4B, 5B, 6B, and 7B are sectional views of the TFT array panel shown in FIGS. 3A, 4A, 5A, 6A, and 7A taken along the lines IIIB-IIIB′, IVB-IVB′, VB-VB′, VIB-VIB′, and VIIB-VIIB′, respectively.

FIG. 8 is a layout view of a TFT array panel for an LCD according to another embodiment of the present invention;

FIG. 9 is a sectional view of the TFT array panel shown in FIG. 8 taken along the line IX-IX′;

FIG. 10 is a sectional view of the TFT array panel shown in FIG. 8 taken along the lines X-X′;

FIG. 11 is a layout view of a TFT array panel shown in FIGS. 8-10 in the first step of a manufacturing method thereof according to an embodiment of the present invention;

FIGS. 12A and 12B are sectional views of the TFT array panel shown in FIG. 11 taken along the lines XIIA-XIIA′ and XIIB-XIIB′, respectively;

FIGS. 13A and 13B illustrate the sectional views of the TFT array panel shown in FIGS. 12A and 12B, respectively, after a deposition step.

FIGS. 14A and 14B illustrate the sectional views of the TFT array panel shown in FIGS. 13A and 13B, respectively, following an etch step.

FIG. 15 is a layout view of the TFT array panel following the step shown in FIGS. 14A and 14B;

FIGS. 16A and 16B are sectional views of the TFT array panel shown in FIG. 15 taken along the lines XVIA-XVIA′ and XVIB-XVIB′, respectively;

FIG. 17 is a layout view of the TFT array panel following the step shown in FIGS. 15, 16A, and 16B;

FIGS. 18A and 18B are sectional views of the TFT array panel shown in FIG. 17 taken along the lines XVIIIA-XVIIIA′ and XVIIIB-XVIIIB′, respectively;

FIG. 19 is a layout view of the TFT array panel following the step shown in FIGS. 17, 18A, and 18B;

FIGS. 20A and 20B are sectional views of the TFT array panel shown in FIG. 19 taken along the lines XXA-XXA′ and XXB-XXB′, respectively;

FIG. 21 is a layout view of a TFT array panel for an LCD according to another embodiment of the present invention; and

FIG. 22 is a sectional view of the TFT array panel shown in FIG. 21 taken along the line XXII-XXII′.

### DETAILED DESCRIPTION

The present invention now will be described more fully hereinafter with reference to the accompanying drawings, in which embodiments of the invention are shown. The present invention may be embodied in many different forms and should not be construed as limited to the embodiments set forth herein.

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Thin film transistor array panels according to embodiments of the present invention will now be described with reference to the accompanying drawings.

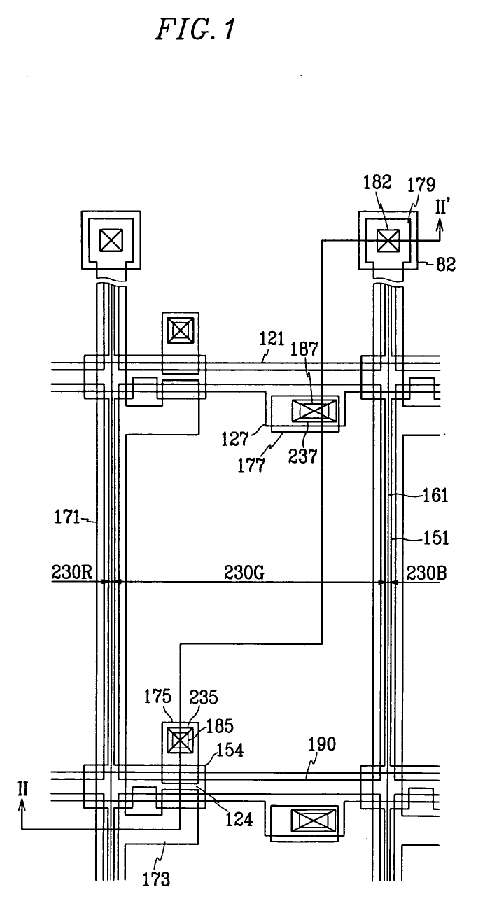

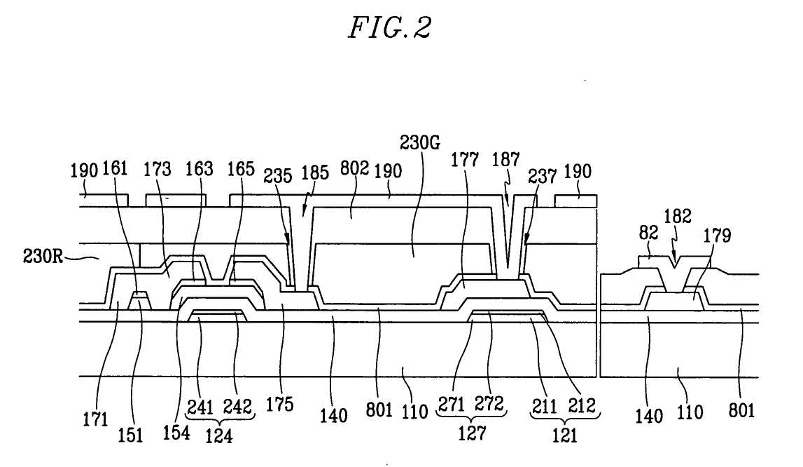

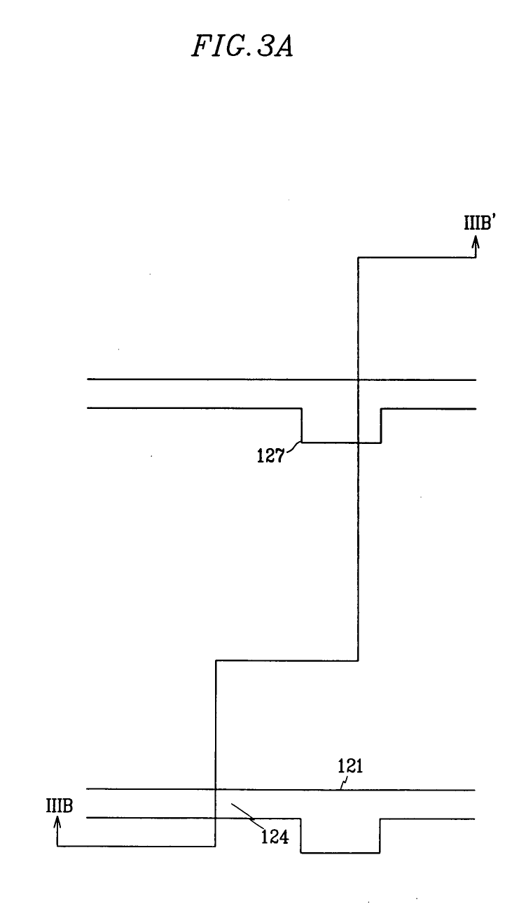

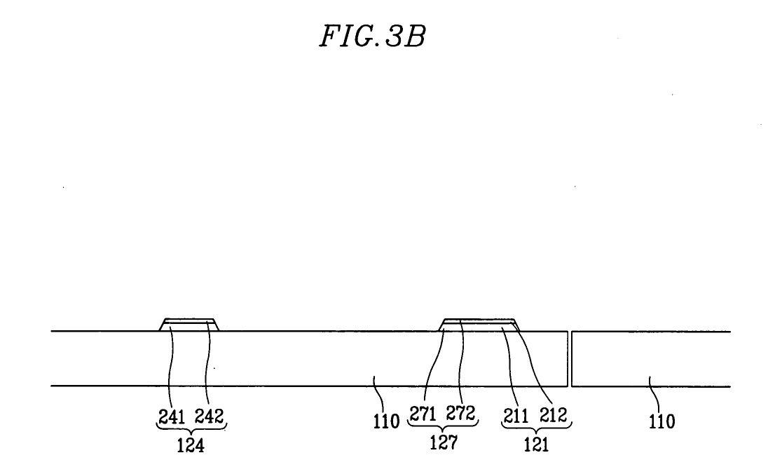

A TFT array panel for an LCD according to an embodiment of the present invention will be described in detail with reference to FIGS. 1 and 2 as well as FIGS. 3A to 7B.

FIG. 1 is a layout view of a TFT array panel for an LCD according to an embodiment of the present invention, and FIG. 2 is a sectional view of the TFT array panel shown in FIG. 1 taken along the line II-II′.

A plurality of gate lines 121 for transmitting gate signals are formed on an insulating substrate 110. Each gate line 121 extends substantially in a transverse direction and includes a plurality of portions forming a plurality of gate electrodes 124 and a plurality of projections 127 protruding downward (see, e.g., FIGS. 2 and 3A). The gate lines 121 are connected to gate driving circuits (not shown) that may be formed or mounted on the substrate 110 or mounted on external devices.

The gate lines 121 include two films having different physical characteristics, a lower film 211 and an upper film 212 (see, e.g., FIGS. 2 and 3B). The upper film 212 is preferably made of low resistivity metal including Al-containing metal such as Al or Al alloy for reducing signal delay or voltage drop in the gate lines 121. On the other hand, the lower film 211 is preferably made of material such as Cr, Mo, and/or Mo alloy including MoW, which has good physical, chemical, and electrical contact characteristics with other materials such as indium tin oxide (ITO) and indium zinc oxide (IZO). A preferable combination of the lower film material and the upper film material is Cr and Al—Nd alloy, respectively. In FIG. 2, the lower and the upper films of the gate electrodes 124 are indicated by reference numerals 241 and 242, respectively, and the lower and the upper films of the projections 127 are indicated by reference numerals 271 and 272, respectively.

The lateral sides of the upper film 212 and the lower film 211 are inclined relative to a surface of the substrate 110, and the inclination angle thereof ranges between about 30 degrees and about 80 degrees.

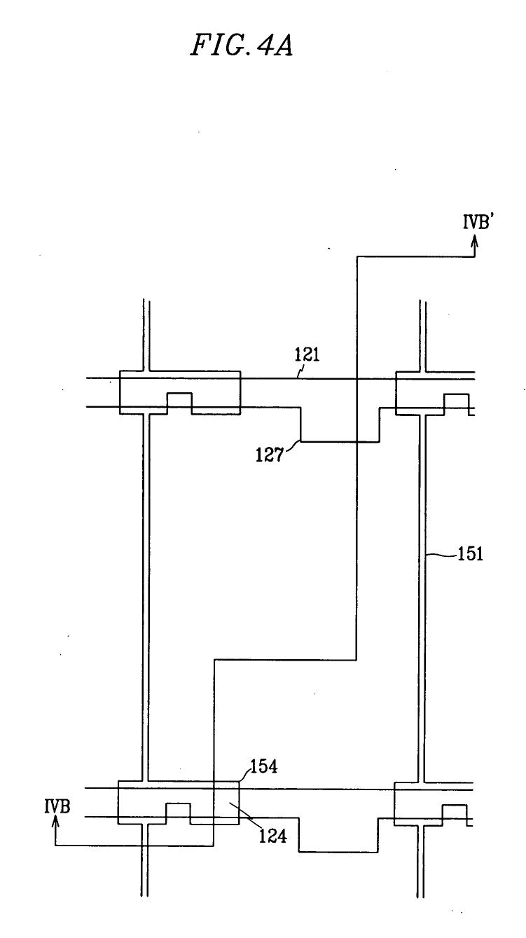

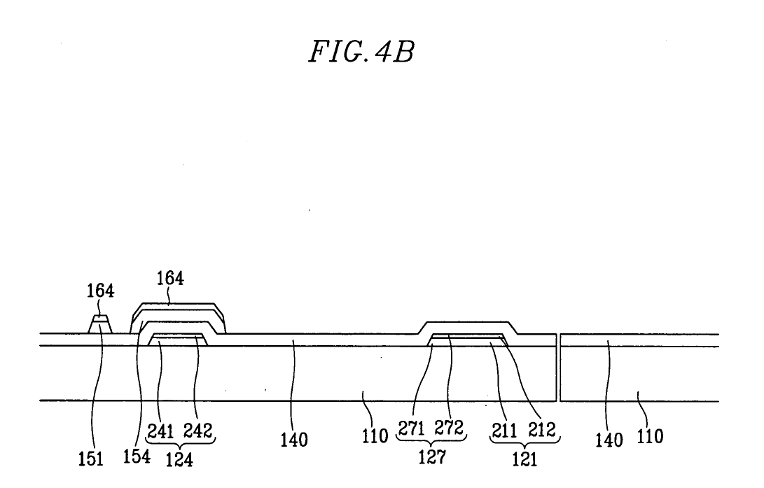

A gate insulating layer 140 preferably made of silicon nitride (SiNx) is formed on the gate lines 121 (see, e.g., FIGS. 2 and 4B)

A plurality of semiconductor stripes 151 preferably made of hydrogenated amorphous silicon (abbreviated “a-Si”) are formed on the gate insulating layer 140. Each semiconductor stripe 151 extends substantially in a longitudinal direction and has a plurality of projections 154 branched out toward the gate electrodes 124 (see, e.g., FIGS. 2 and 4A). The width of each semiconductor stripe 151 becomes large near the gate lines 121 such that the semiconductor stripe 151 covers large areas of the gate lines 121.

A plurality of ohmic contact stripes and islands 161 and 165 preferably made of silicide or n+ hydrogenated a-Si heavily doped with n-type impurity are formed on the semiconductor stripes 151. Each ohmic contact stripe 161 has a plurality of projections 163, and the projections 163 and the ohmic contact islands 165 are located in pairs on the projections 154 of the semiconductor stripes 151.

The lateral sides of the semiconductor stripes 151 and the ohmic contacts 161 and 165 are tapered, and the inclination angles thereof are preferably in a range between about 30 degrees and about 80 degrees.

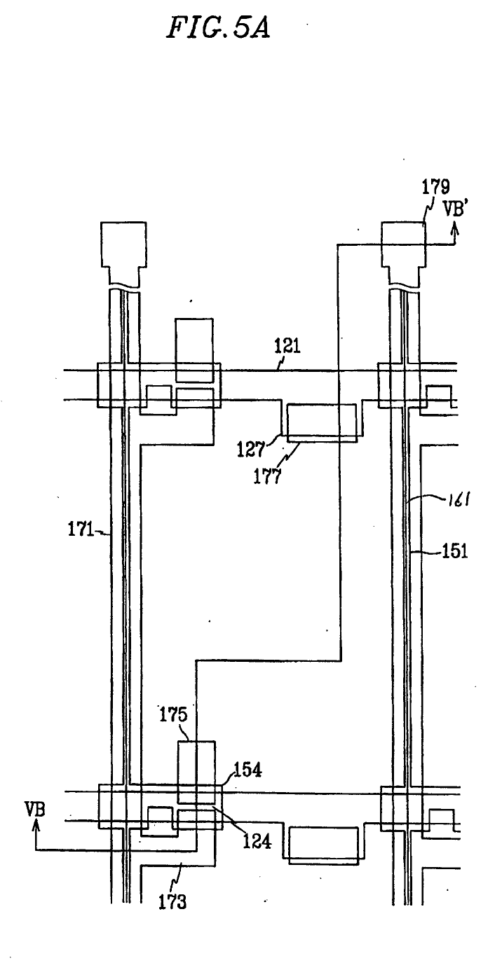

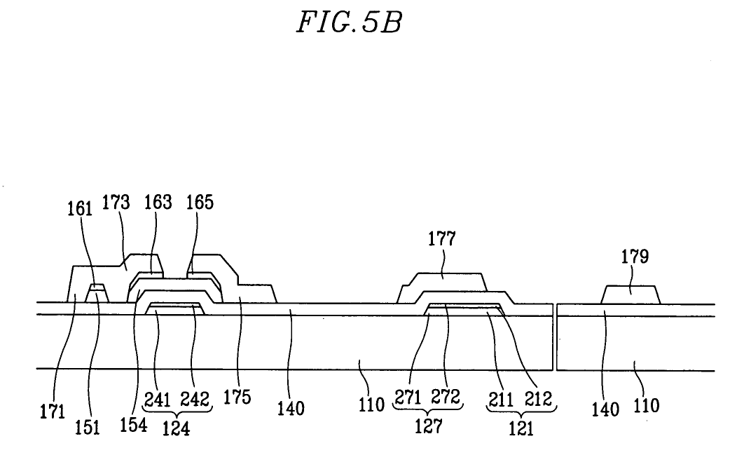

A plurality of data lines 171, a plurality of drain electrodes 175, and a plurality of storage capacitor conductors 177 are formed on the ohmic contacts 161 and 165 and the gate insulating layer 140 (see, e.g., FIGS. 2, 5A, and SB).

The data lines 171 for transmitting data voltages extend substantially in the longitudinal direction and intersect the gate lines 121 (see, e.g., FIGS. 2 and 5A). Each data line 171 includes a plurality of branches projecting toward the drain electrodes 175 to form a plurality of source electrodes 173 and has an end portion 179 having a large area for contact with another layer or an external device. Each pair of the source electrodes 173 and the drain electrodes 175 are separated from each other and opposite each other with respect to a gate electrode 124. Agate electrode 124, a source electrode 173, a drain electrode 175, and a projection 154 of a semiconductor stripe 151, form a TFT having a channel formed in the projection 154 disposed between the source electrode 173 and the drain electrode 175.

The storage capacitor conductors 177 overlap the projections 127 of the gate lines 121.

The data lines 171, the drain electrodes 175, and the storage capacitor conductors 177 are preferably made of Al, Mo, Cr, or alloys thereof. They may have a double-layered structure, including for example an upper layer of Mo and a lower layer of Al, or a triple-layered structure including a middle layer of Al.

Like the gate lines 121, the data lines 171, the drain electrodes 175, and the storage capacitor conductors 177 have tapered lateral sides, and the inclination angles thereof may range between about 30 degrees and about 80 degrees.

The ohmic contacts 161 and 165 are interposed only between the underlying semiconductor stripes 151 and the overlying data lines 171 and the overlying drain electrodes 175, respectively, and reduce the contact resistance therebetween. The semiconductor stripes 151 include a plurality of exposed portions, which are not covered with the data lines 171 and the drain electrodes 175, such as portions located between the source electrodes 173 and the drain electrodes 175. Although the semiconductor stripes 151 are narrower than the data lines 171 at most places, the width of the semiconductor stripes 151 becomes large near the gate lines 121 as described above, to smooth the profile of the surface, thereby preventing the disconnection of the data lines 171.

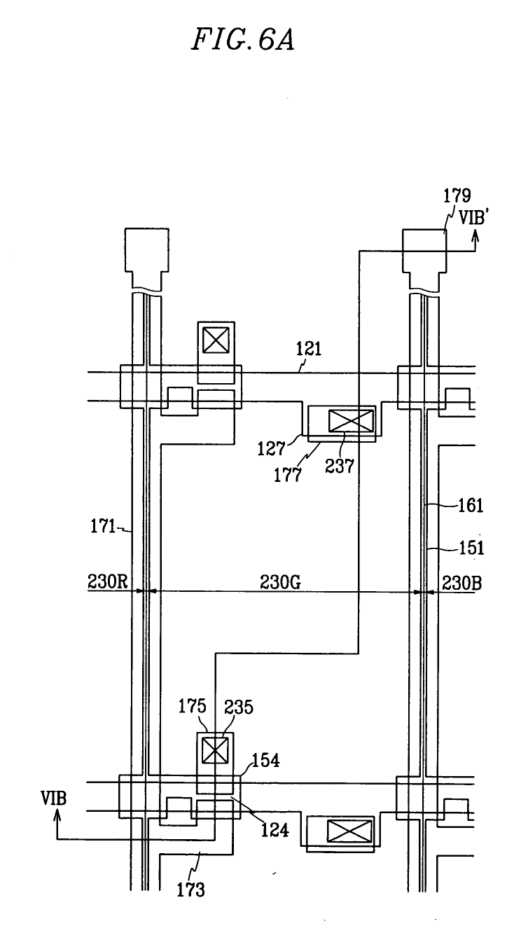

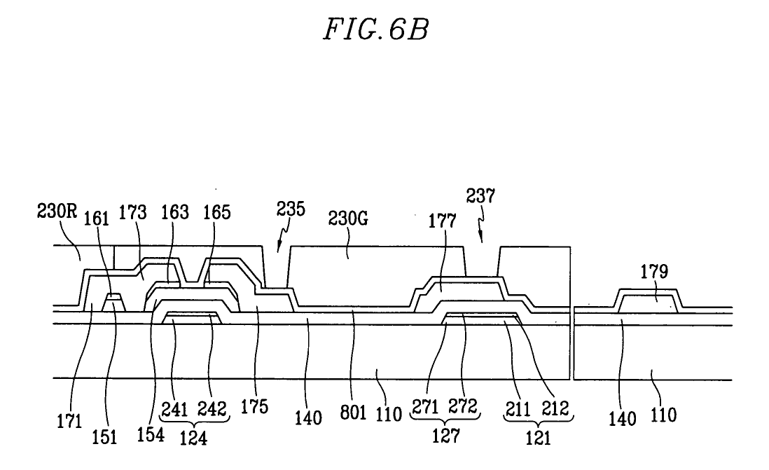

A first passivation layer 801, preferably made of silicon nitride or silicon oxide, is formed on the data lines 171, the drain electrodes 175, the storage capacitor conductors 177, and the exposed portions of the semiconductor stripes 151 (see, e.g., FIGS. 2 and 6B).

A plurality of red, green, and blue color filter stripes 230R, 230G, and 230B are formed on the first passivation layer 801. Each of the color filter stripes 230R, 230G, and 230B are disposed substantially between two adjacent data lines 171 and extends in a longitudinal direction (see, e.g., FIGS. 2 and 6A). The color filter stripes 230R, 230G, and 230B are not disposed on a peripheral area which is provided with the end portions 179 of the data lines 171. The color filter stripes 230R, 230G, and 230B have a plurality of apertures or openings 235 and 237 placed on the drain electrodes 175 and the storage capacitor conductors 177, respectively, and have tapered sidewalls. Edges of adjacent color filter stripes 230R, 230G, and 230B substantially match with each other, preferably matching exactly. However, the edges may overlap to block the light leakage between the pixel areas, and the edges may be tapered or thinner than other portions for improving step coverage of overlying layers and for planarizing a surface to prevent misalignment of the LC molecules. It is preferable that the overlapping portions fully cover the data lines 171.

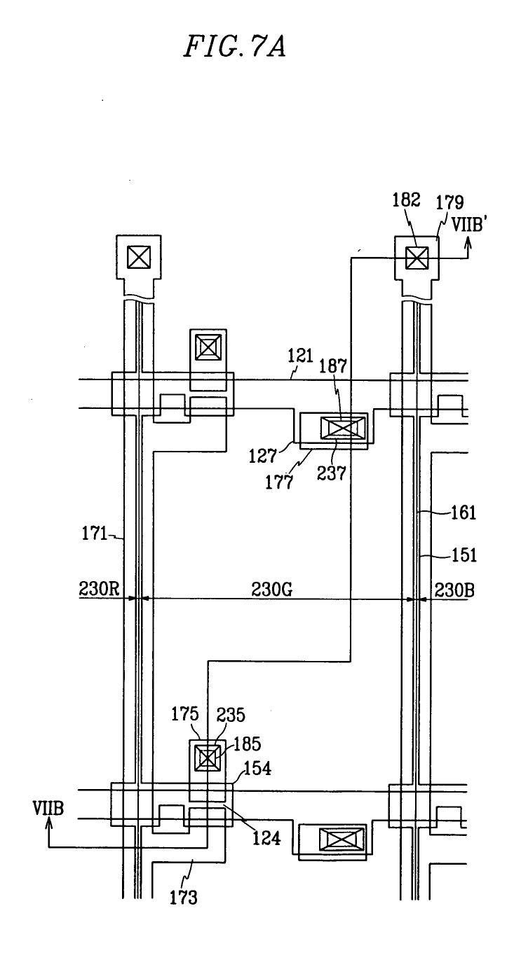

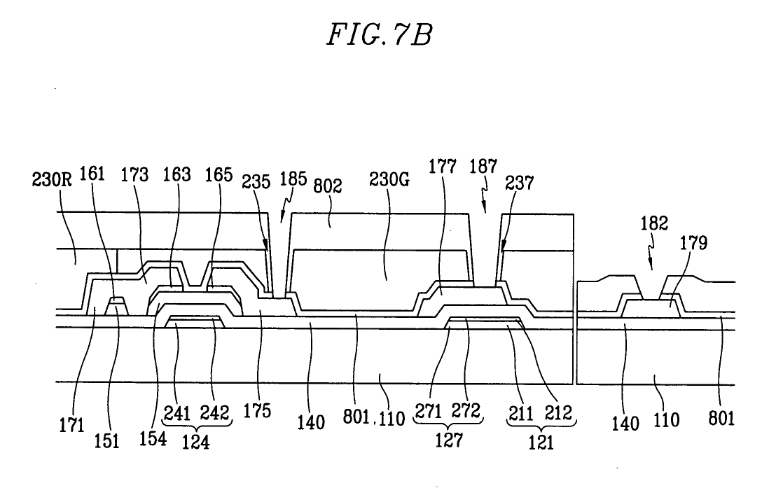

A second passivation layer 802 is formed on the adjacent color filter stripes 230R, 230G, and 230B (see, e.g., FIGS. 2 and 7B). The second passivation layer 802 is preferably made of photosensitive organic material having a good flatness characteristic or low dielectric insulating material such as a-Si:C:O or a-Si:O:F formed by plasma enhanced chemical vapor deposition (PECVD) in one example.

The passivation layers 801 and 802 have a plurality of contact holes 182, 185, and 187 exposing the end portions 179 of the data lines 171, the drain electrodes 175, and the storage conductors 177, respectively (see, e.g., FIGS. 2 and 7A). The contact holes 182, 185, and 187 have inclined sidewalls and the contact holes 185 and 187 are disposed within the openings 235 and 237 of the color filter stripes 230R, 230G, and 230B. Accordingly, boundaries of the first and the second passivation layers 801 and 802 at the contact holes 182, 185, and 187 coincide with each other. However, the contact holes 185 and 187 may expose a top surface of the color filter stripes 230R, 230G, and 230B to have stepped profiles.

In addition, the passivation layers 801 and 802 and the gate insulating layer 140 may have a plurality of contact holes (not shown) exposing end portions of the gate lines 121 when the gate driving circuits or external devices in the form of integrated circuit (IC) chips are mounted on the TFT array panel.

When the data lines 171, the drain electrodes 175, and the storage capacitor conductors 177 have a double-layered structure including lower and upper films, the upper film, if made of Al-containing metal, may be removed in the contact holes 182, 185, and 187 to expose the lower film. Furthermore, the contact holes 185 and 187 may expose edges of the data lines 171, the drain electrodes 175, the storage capacitor conductors 177, and some portions of the gate insulating layer 140.

A plurality of pixel electrodes 190 and a plurality of contact assistants 82, which are preferably made of ITO or IZO, are formed on the passivation layer 802. A plurality of additional contact assistants (not shown) maybe formed on the second passivation layer 802 and connected to the end portions of the gate lines 121 through the above-described contact holes exposing the end portions of the gate lines 121.

The pixel electrodes 190 are physically and electrically connected to the drain electrodes 175 through the contact holes 185 and to the storage capacitor conductors 177 through the contact holes 187 such that the pixel electrodes 190 receive the data voltages from the drain electrodes 175 and transmit the received data voltages to the storage capacitor conductors 177.

The pixel electrodes 190 supplied with the data voltages generate electric fields in cooperation with a common electrode (not shown) on another panel (not shown), which reorient liquid crystal molecules in a liquid crystal layer disposed between the pixel electrode and the common electrode.

The pixel electrode 190 and the common electrode form a “liquid crystal capacitor,” which stores applied voltages after turning off the TFT. An additional capacitor called a “storage capacitor,” which is connected in parallel to the liquid crystal capacitor, is provided for enhancing the voltage storing capacity. The storage capacitors are implemented by overlapping the pixel electrodes 190 with the gate lines 121 adjacent thereto (called “previous gate lines”). The capacitances of the storage capacitors, i.e., the storage capacitances, are increased by providing the projections 127 at the gate lines 121 for increasing overlapping areas and by providing the storage capacitor conductors 177, which are connected to the pixel electrodes 190 and overlap the projections 127, under the pixel electrodes 190 for decreasing the distance between the terminals.

The pixel electrodes 190 overlap the gate lines 121 and the data lines 171 to increase aperture ratio but this is optional.

The contact assistants 82 are connected to the exposed end portions 179 of the data lines 171 through the contact holes 182. The contact assistants 82 protect the exposed portions 179 and complement the adhesiveness of the exposed portions 179 to external devices.

According to another embodiment of the present invention, the pixel electrodes 190 are made of transparent conductive polymer. For a reflective LCD, the pixel electrodes 190 are made of opaque reflective metal. In these cases, the contact assistants 82 may be made of material such as ITO or IZO different from the pixel electrodes 190.

A method of manufacturing the TFT array panel shown in FIGS. 1 and 2 according to an embodiment of the present invention will be now described in detail with reference to FIGS. 3A to 7B as well as FIGS. 1 and 2.

FIGS. 3A, 4A, 5A, 6A, and 7A are layout views of the TFT array panel shown in FIGS. 1 and 2 in intermediate steps of a manufacturing method thereof according to an embodiment of the present invention. FIGS. 3B, 4B, 5B, 6B, and 7B are sectional views of the TFT array panel shown in FIGS. 3A, 4A, 5A, 6A, and 7A, respectively, taken along the lines IIIB-IIIB′, IVB-IVB′, VB-VB′, VIB-VIB′, and VIIB-VIIB′, respectively.

Two conductive films, a lower conductive film and an upper conductive film, are sputtered in sequence on an insulating substrate 110 such as transparent glass. The lower conductive film is preferably made of a metal such as Cr, Mo, and Mo alloy including MoW, which has good contact characteristics with ITO or IZO, and the film has a thickness of about 500 Å in one example. The upper conductive film is preferably made of Al-containing metal and preferably has a thickness of about 2,500 Å.

Referring now to FIGS. 3A and 3B, the upper conductive film and the lower conductive film are patterned in sequence by photo-etching with a photoresist pattern to form a plurality of gate lines 121 including a plurality of gate electrodes 124 and a plurality of projections 127. Although the lower and the upper films 211 and 212 may be separately etched under different conditions, they may be simultaneously etched preferably using, in one example, an Al etchant including about 8-15% CH₃COOH, about 5-8% HNO₃, about 50-60% H₃PO₃, and about 17-37% H₂O, which can etch both Al and Mo with inclined etch profiles.

Referring to FIGS. 4A and 4B, after sequential deposition of a gate insulating layer 140, an intrinsic a-Si layer, and an extrinsic a-Si layer, the extrinsic a-Si layer and the intrinsic a-Si layer are photo-etched to form a plurality of extrinsic semiconductor stripes 164 and a plurality of intrinsic semiconductor stripes 151 including a plurality of projections 154 on the gate insulating layer 140. The gate insulating layer 140 is preferably made of silicon nitride with thickness of about 2,000 Å to about 5,000 Å, and the deposition temperature is preferably in a range between about 250° C. and about 500° C.

Referring to FIGS. 5A and 5B, a conductive layer is sputtered and etched to form a plurality of data lines 171 including a plurality of source electrodes 173, a plurality of drain electrodes 175, and a plurality of storage capacitor conductors 177.

Thereafter, portions of the extrinsic semiconductor stripes 164 (FIG. 4B), which are not covered with the data lines 171, the drain electrodes 175, and the storage capacitor conductors 177, are removed to complete formation of a plurality of ohmic contact stripes 161 including a plurality of projections 163 and a plurality of ohmic contact islands 165 and to expose portions of the intrinsic semiconductor stripes 151 including a plurality of projections 154. Oxygen plasma treatment preferably follows thereafter in order to stabilize the exposed surfaces of the semiconductor stripes 151.

Referring to FIGS. 6A and 6B, a first passivation layer 801, made of silicon nitride in one example, is deposited over the topography of the structure illustrated in FIG. 5B, and photosensitive organic films respectively containing red, green, and blue pigments are coated on the first passivation layer 801 and patterned by photolithography to form a plurality of color filter stripes 230R, 230G, and 230B in a sequential manner. The color filter stripes have a plurality of openings 235 and 237 exposing portions of the first passivation layer 801 that are disposed on the drain electrodes 175 and the storage capacitor conductors 177, respectively.

Referring to FIGS. 7A and 7B, a second passivation layer 802 is deposited on the color filter stripes 230R, 230G, and 230B. Then the first and the second passivation layers 801 and 802 (layer 140 may also be etched) are patterned in one step, in one example by dry etch, to form a plurality of contact holes 182, 185, and 187. The first and second passivation layers 801 and 802 are simultaneously patterned through the plurality of openings 235 and 237 such that portions of a second passivation layer 802 remain adjacent to respective color filter stripes and such that the etched boundaries of the passivation layers 801 and 802 match and share a common edge, thereby advantageously forming an insulation boundary of layers 801 and 802 for respective color filter stripes proximate the contact holes. In addition, the simultaneous patterning facilitates formation of inclined sidewalls of the contact holes 182, 185, and 187, which helps to prevent the disconnection of overlying layers and minimizes contact resistance. Furthermore, the simultaneous patterning requires only one step and no additional step, thereby simplifying the manufacturing process and minimizing the manufacturing cost.

If portions of an Al upper film are exposed through the contact holes 182, 185, and 187, the portions of the Al film are preferably removed to expose a lower film.

Finally, as shown in FIGS. 1 and 2, a plurality of pixel electrodes 190 and a plurality of contact assistants 82 are formed on the second passivation layer 802 by sputtering and photo-etching an ITO or IZO layer. The sputtering temperature of the ITO or IZO layer is preferably lower than about 250 degrees for minimizing resistance.

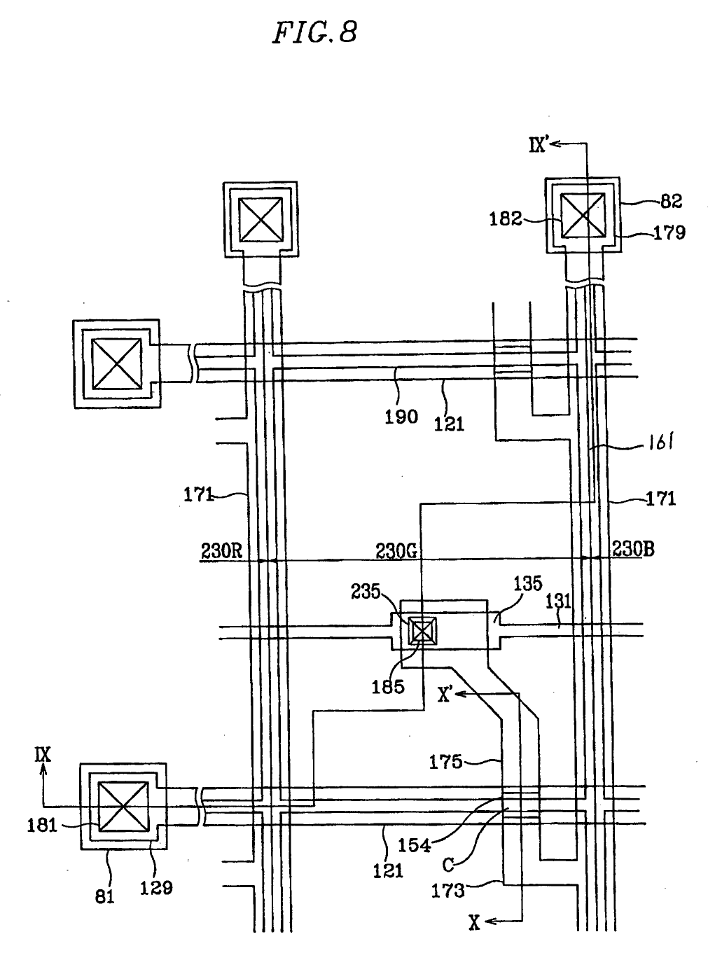

A TFT array panel for an LCD according to another embodiment of the present invention will be described in detail with reference to FIGS. 8-10.

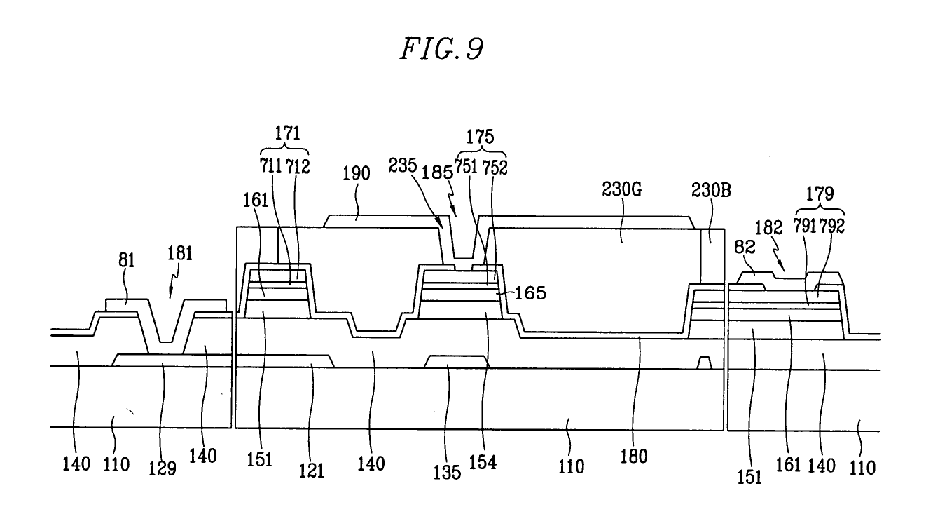

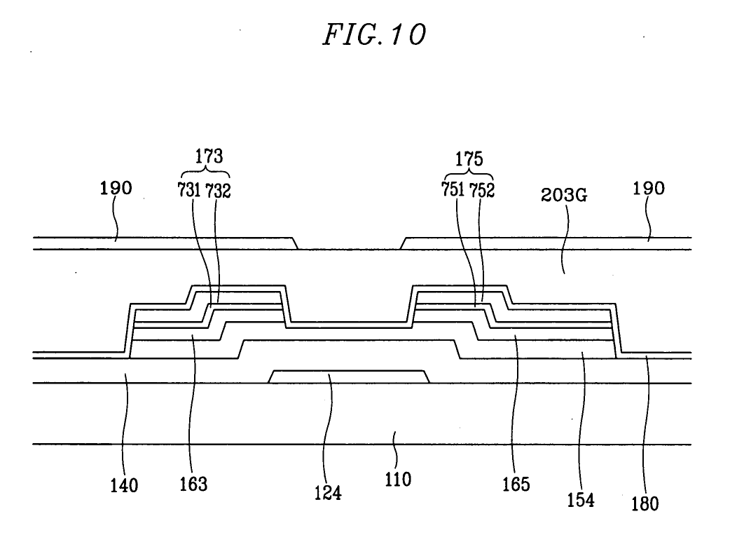

FIG. 8 is a layout view of a TFT array panel for an LCD according to another embodiment of the present invention, FIG. 9 is a sectional view of the TFT array panel shown in FIG. 8 taken along the line IX-IX′, and FIG. 10 is a sectional view of the TFT array panel shown in FIG. 8 taken along the line X-X′.

Referring to FIGS. 8-10, a layered structure of the TFT array panel according to this embodiment is similar to the structure shown in FIGS. 1 and 2.

That is, a plurality of gate lines 121 including a plurality of gate electrodes 124, are formed on a substrate 110. A gate insulating layer 140, a plurality of semiconductor stripes 151 including a plurality of projections 154, and a plurality of ohmic contact stripes 161 including a plurality of projections 163 and a plurality of ohmic contact islands 165, are sequentially formed thereon. A plurality of data lines 171 including a plurality of source electrodes 173 and a plurality of drain electrodes 175 including expansions are formed on the ohmic contacts 161 and 165, respectively, and a passivation layer 180 (that corresponds to the first passivation layer 801 shown in FIG. 2) and a plurality of color filter stripes 230R, 230G, and 230B are formed thereon. A plurality of contact holes 182 and 185 are provided at the passivation layer 180 and the gate insulating layer 140, and a plurality of openings 235 are provided at the color filter stripes 230R, 230G, and 230B. A plurality of pixel electrodes 190 are formed over the color filter stripes 230R, 230G, and 230B, and a plurality of contact assistants 82 are formed over end portions 179.

Different from the TFT array panel shown in FIGS. 1 and 2, the TFT array panel according to this embodiment provides a plurality of storage electrode lines 131, including a plurality of storage electrodes 135, which are on the same layer as the gate lines 121 but separated from the gate lines 121. The storage electrode lines 131 are supplied with a predetermined voltage such as the common voltage. Without providing the storage capacitor conductors 177 shown in FIGS. 1 and 2, the drain electrodes 175 extend to overlap the storage electrode lines 131 to form storage capacitors. The storage electrode lines 131 may be omitted if the storage capacitance generated by the overlap of the gate lines 121 and the pixel electrodes 190 is sufficient. The storage electrode lines 131 may be disposed near the gate lines 121 to increase the aperture ratio.

Furthermore, there is no additional passivation layer on the color filter stripes 230R, 230G, and 230B and thus the pixel electrodes 190 contact a top surface of the color filter stripes 230R, 230G, and 230B and sidewalls of the openings 235 of the color filter stripes 230R, 230G, and 230B as well as the contact holes 185 of the passivation layer 180 such that the pixel electrodes 190 have stepped profiles since the openings 235 are larger than the contact holes 185.

In addition, the gate lines 121 include a single layer, while the data lines 171 and the drain electrodes 175 have a double-layered structure. The data lines 171 and the drain electrodes 175 include a lower film 711 and 751, respectively, made of Cr, Mo, or Mo alloy such as MoW in one example, and an upper film 712 and 752, respectively, made of Al or Al alloy such as AlNd in one example. In FIGS. 9 and 10, the lower and the upper films of the source electrodes 173 are indicated by reference numerals 731 and 732, respectively, and the lower and the upper films of the end portions 179 of the data lines 171 are indicated by reference numerals 791 and 792, respectively.

Moreover, each gate line 121 has an end portion 129 having a large area and connected to a contact assistant 81, which is formed on the same layer as the pixel electrodes 190, through a contact hole 181.

The semiconductor stripes 151 have almost the same planar shapes as the data lines 171 and the drain electrodes 175 as well as the underlying ohmic contacts 161 and 165. However, the projections 154 of the semiconductor stripes 151 include some exposed portions, which are not covered with the data lines 171 and the drain electrodes 175, such as portions located between the source electrodes 173 and the drain electrodes 175.

Many of the above-described features of the TFT array panel for an LCD shown in FIGS. 1 and 2 may be appropriate to the TFT array panel shown in FIGS. 8-10.

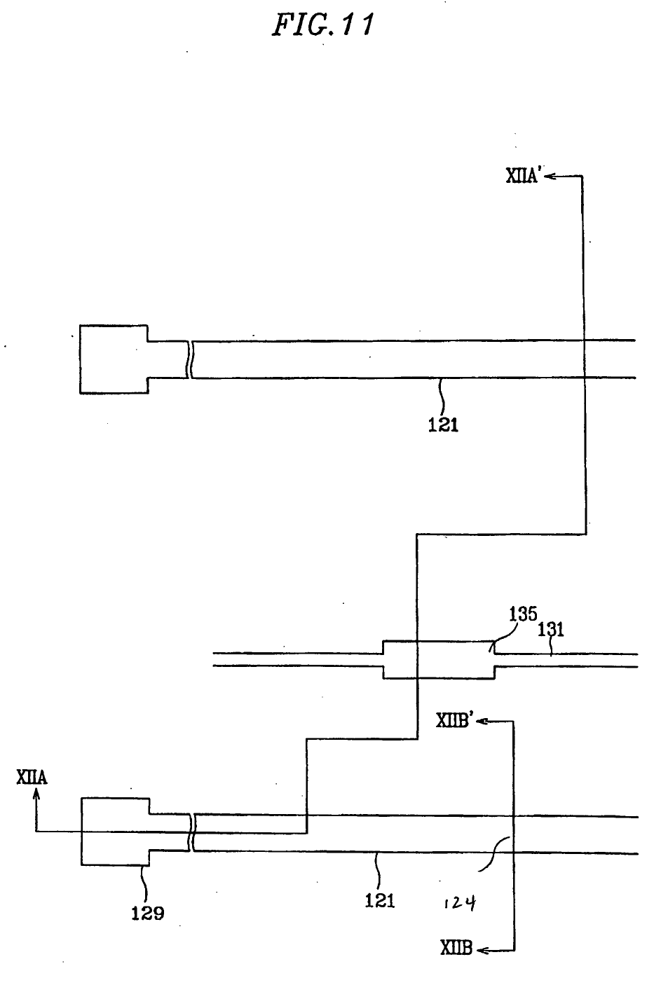

Now, a method of manufacturing the TFT array panel shown in FIGS. 8-10 according to an embodiment of the present invention will be described in detail with reference to FIGS. 11-20B as well as FIGS. 8-10.

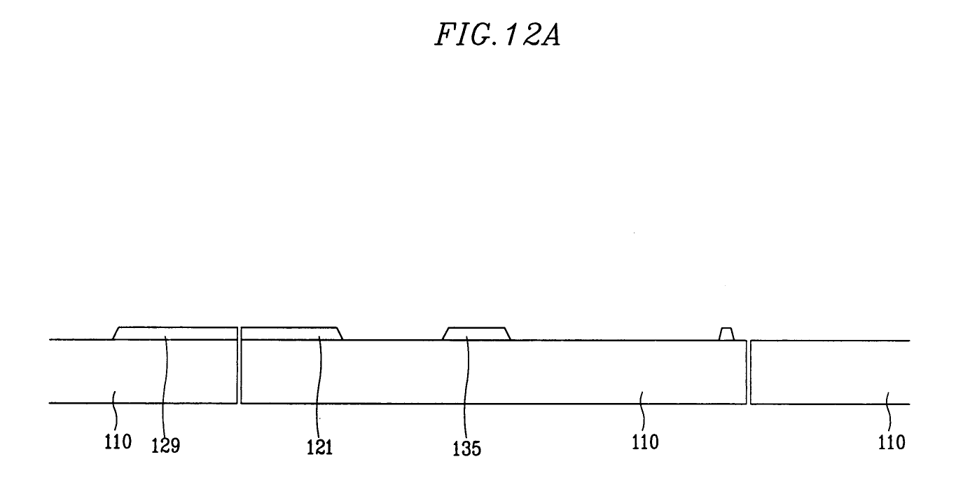

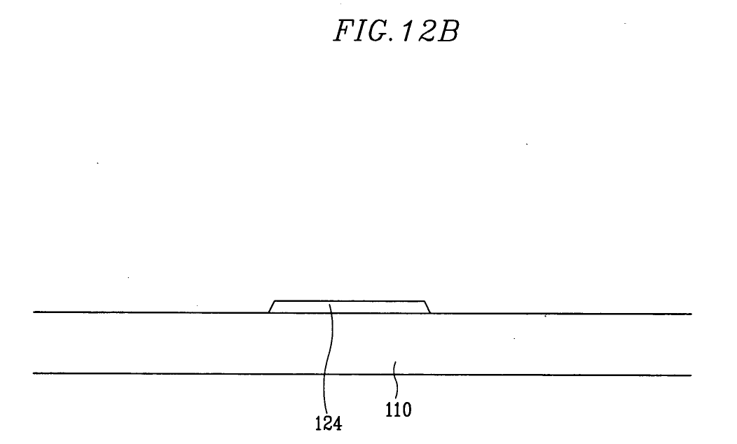

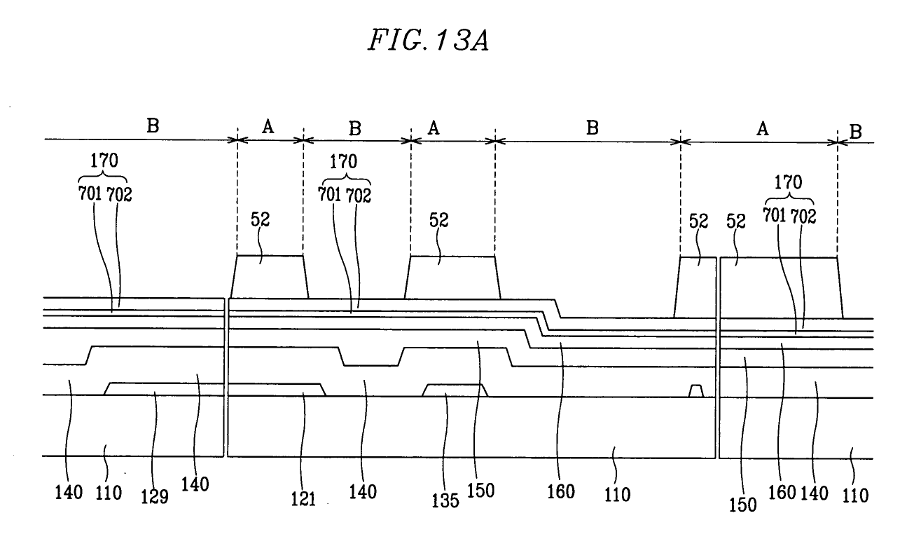

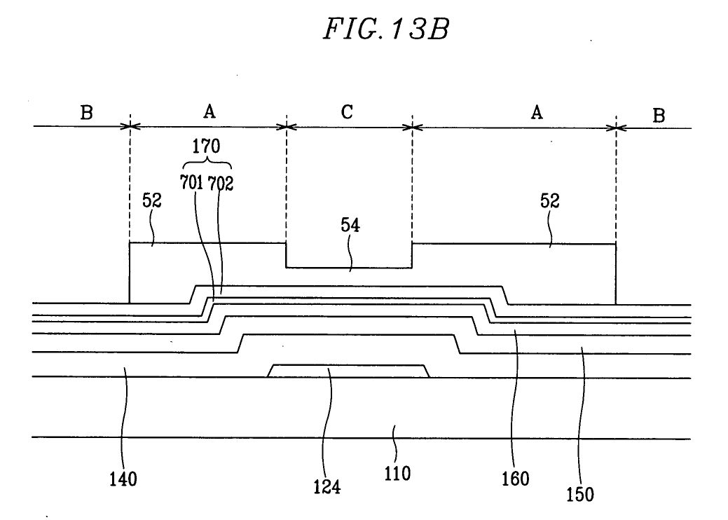

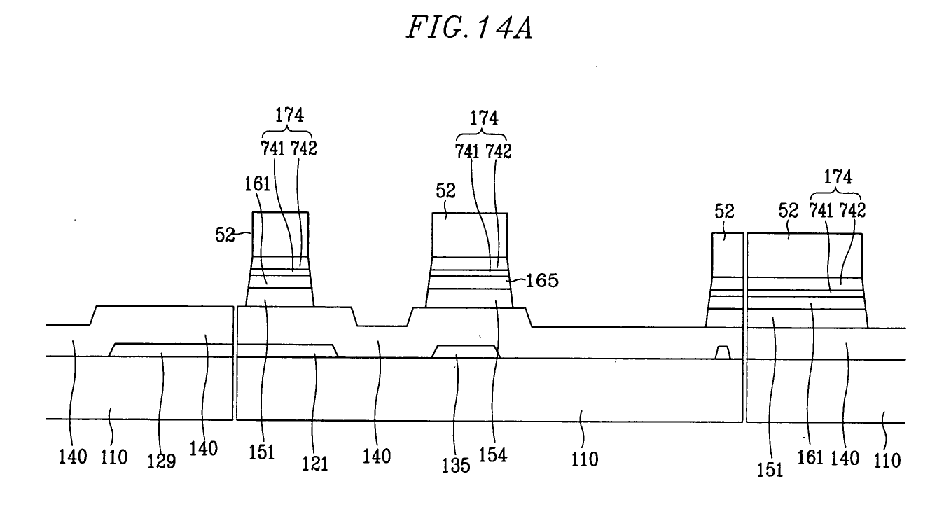

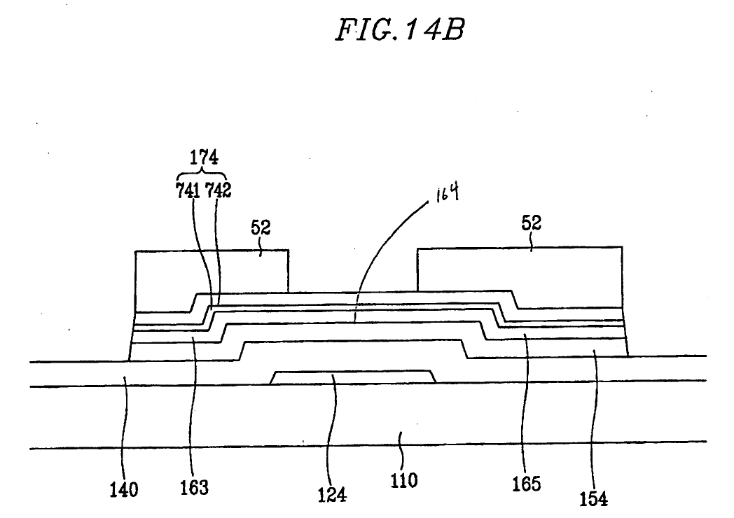

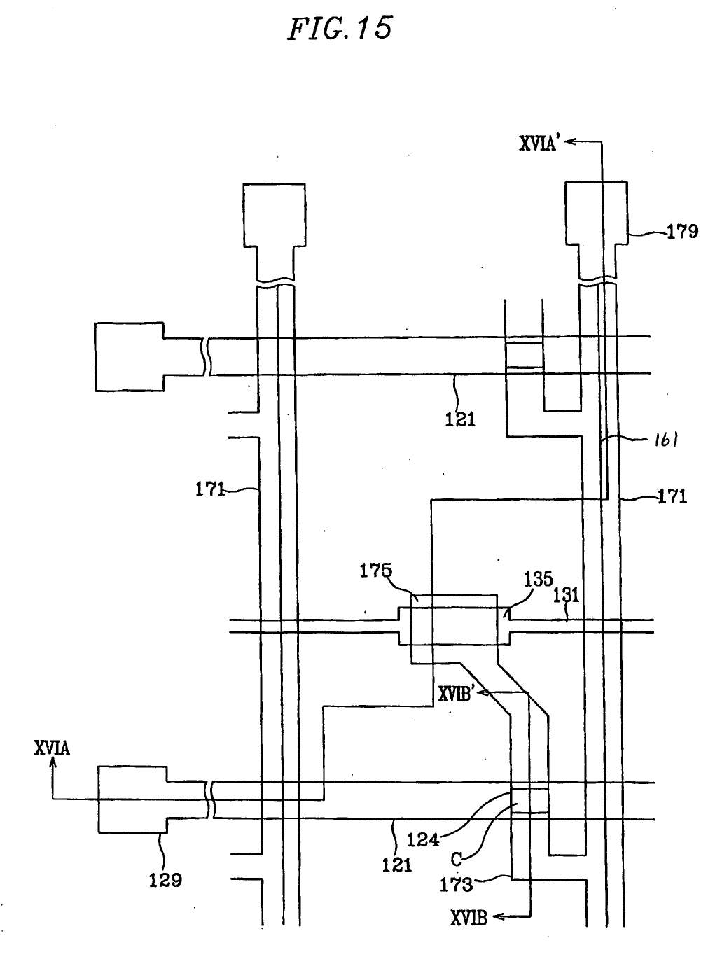

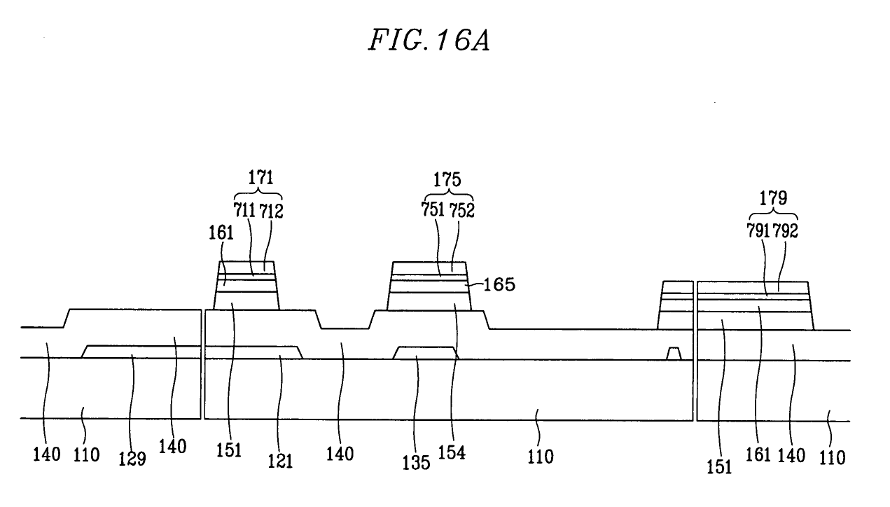

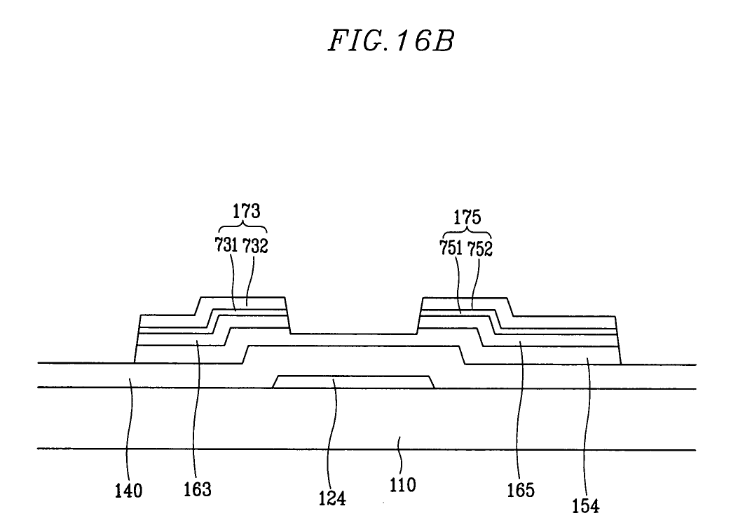

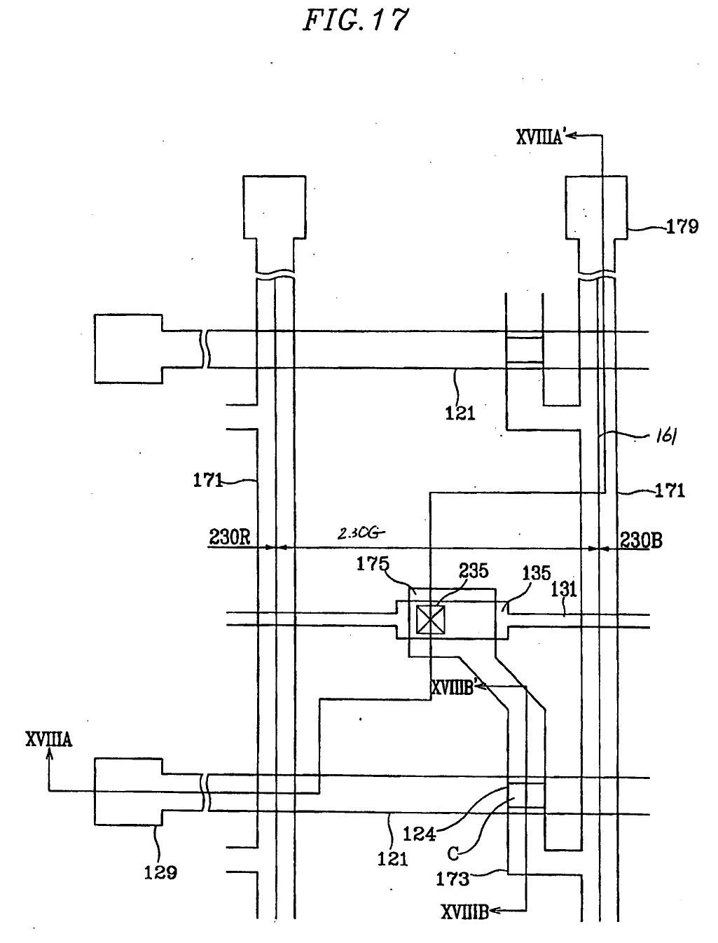

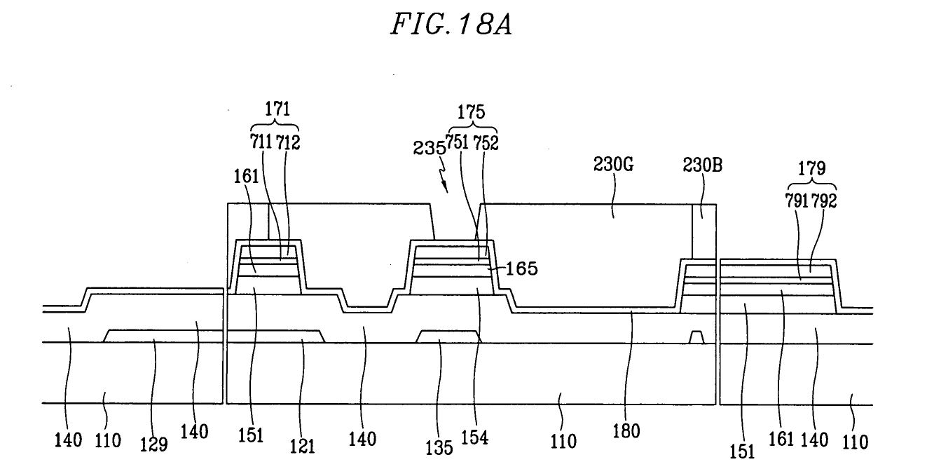

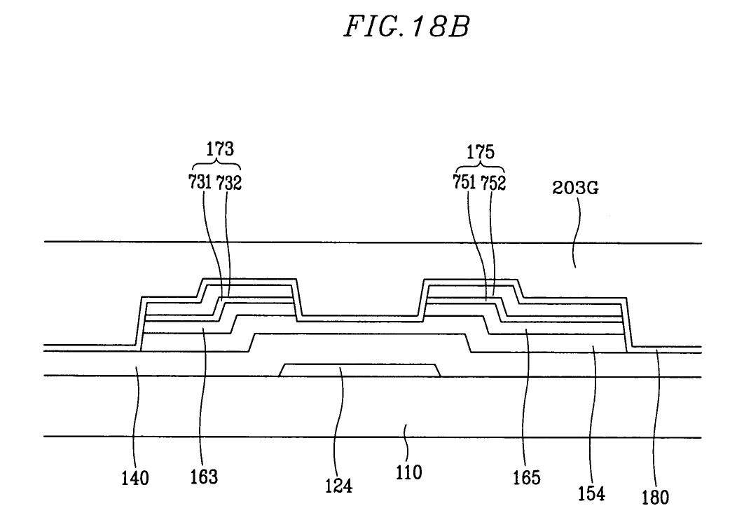

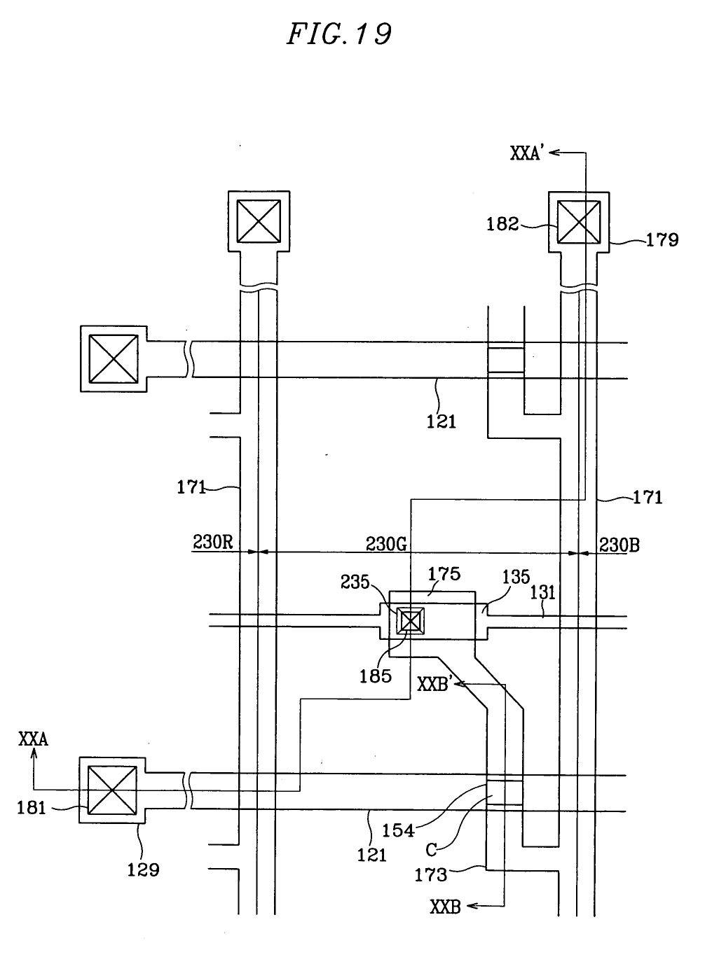

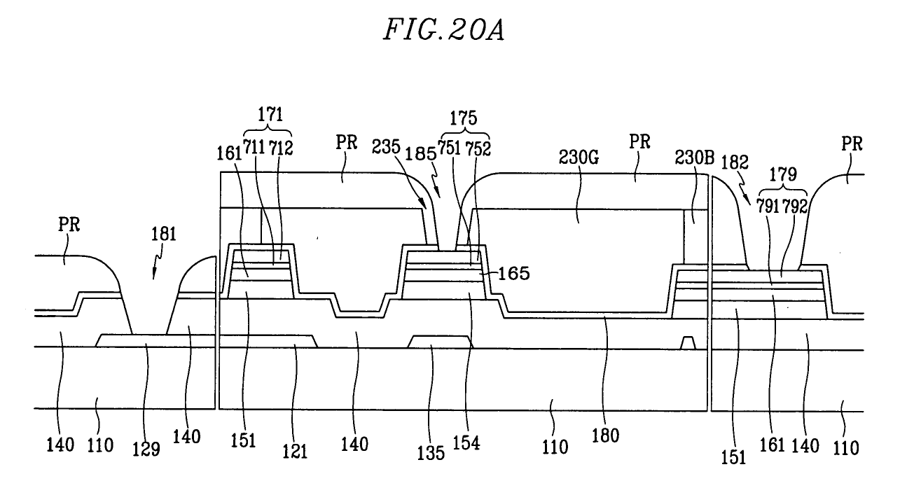

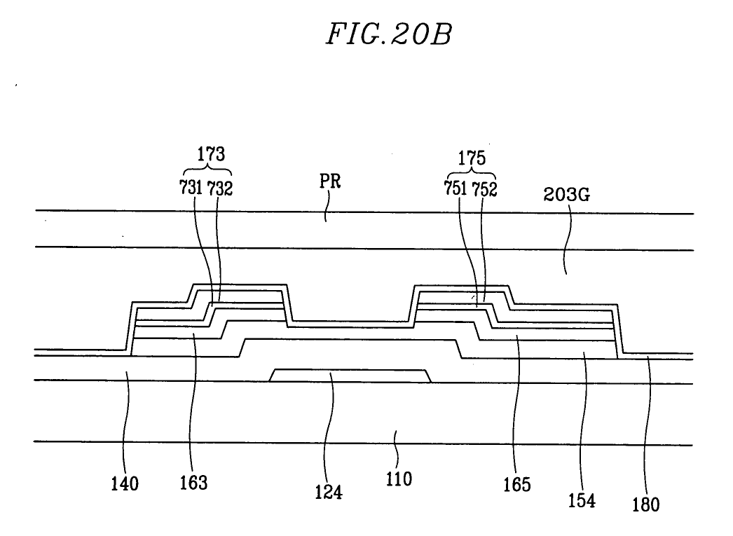

FIG. 11 is a layout view of a TFT array panel shown in FIGS. 8-10 in the first step of a manufacturing method thereof according to an embodiment of the present invention; FIGS. 12A and 12B are sectional views of the TFT array panel shown in FIG. 11 taken along the lines XIIA-XIIA′ and XIIB-XIIB′, respectively; FIGS. 13A and 13B illustrate sectional views of the TFT array panel shown in FIGS. 12A and 12B taken along the lines XIIA-XIIA′ and XIIB-XIIB′, respectively, following a deposition step; FIGS. 14A and 14B illustrate sectional views of the TFT array panel shown in FIGS. 13A and 13B, respectively, following an etch step; FIG. 15 is a layout view of the TFT array panel following the step shown in FIGS. 14A and 14B; FIGS. 16A and 16B are sectional views of the TFT array panel shown in FIG. 15 taken along the lines XVIA-XVIA′ and XVIB-XVIB′, respectively; FIG. 17 is a layout view of the TFT array panel following the step shown in FIGS. 15, 16A, and 16B; FIGS. 18A and 18B are sectional views of the TFT array panel shown in FIG. 17 taken along the lines XVIIIA-XVIIIA′ and XVIIIB-XVIIIB′, respectively; FIG. 19 is a layout view of the TFT array panel following the step shown in FIGS. 17, 18A, and 18B; and FIGS. 20A and 20B are sectional views of the TFT array panel shown in FIG. 19 taken along the lines XXA-XXA′ and XXB-XXB′, respectively.

Referring to FIGS. 11, 12A, and 12B, a plurality of gate lines 121 including a plurality of gate electrodes 124 and a plurality of storage electrode lines 131 are formed on a substrate 110 by depositing and photo-etching a conductive film.

As shown in FIGS. 13A and 13B, a gate insulating layer 140, an intrinsic a-Si layer 150, and an extrinsic a-Si layer 160 are sequentially deposited by CVD such that the layers 140, 150, and 160 have a thickness of about 1,500 Å to about 5,000 Å, about 500 Å to about 2,000 Å, and about 300 Å to about 600 Å, respectively. A conductive layer 170 including a lower film 701 and an upper film 702 is deposited by sputtering, and a photoresist film with a thickness of about 1-2 microns is coated on the conductive layer 170.

The photoresist film is exposed to light through an exposure mask (not shown), and developed such that the developed photoresist has a position dependent thickness. The photoresist shown in FIGS. 13A and 13B includes a plurality of first to third portions with decreased thickness. The first portions located on wire areas A and the second portions located on channel areas C are indicated by reference numerals 52 and 54, respectively, and no reference numeral is assigned to the third portions located on remaining areas B since the third portions have substantially zero thickness to expose underlying portions of the conductive layer 170. The thickness ratio of the second portions 54 to the first portions 52 is adjusted depending upon the process conditions in subsequent process steps. It is preferable that the thickness of the second portions 54 is equal to or less than half of the thickness of the first portions 52, and in particular, equal to or less than about 4,000 Å.

The position-dependent thickness of the photoresist is obtained by several techniques, for example, by providing translucent areas, transparent areas, and light blocking opaque areas on the exposure mask. In one example, the translucent areas may have a slit pattern, a lattice pattern, and/or include a thin film(s) with intermediate transmittance or intermediate thickness. When using a slit pattern, it is preferable that the width of the slits or the distance between the slits be smaller than the resolution of a light exposer used for the photolithography. Another example is to use reflowable photoresist. Once a photoresist pattern made of a reflowable material is formed by using a normal exposure mask only with transparent areas and opaque areas, it is subject to a reflow process to flow onto areas without the photoresist, thereby forming thin portions.

The different thickness of the photoresist 52 and 54 allows for selectively etching the underlying layers when using suitable process conditions. Therefore, a plurality of data lines 171 including a plurality of source electrodes 173 and a plurality of drain electrodes 175, a plurality of ohmic contact stripes 161 including a plurality of projections 163 and a plurality of ohmic contact islands 165, and a plurality of semiconductor stripes 151 including a plurality of projections 154, are obtained as shown in FIGS. 15, 16A, and 16B by a series of etching steps.

Referring again to FIGS. 13A and 13B, for descriptive purposes, portions of the conductive layer 170, the extrinsic a-Si layer 160, and the intrinsic a-Si layer 150 on the wire areas A are called first portions, portions of the conductive layer 170, the extrinsic a-Si layer 160, and the intrinsic a-Si layer 150 on the channel areas C are called second portions, and portions of the conductive layer 170, the extrinsic a-Si layer 160, and the intrinsic a-Si layer 150 on the remaining areas B are called third portions.

An exemplary sequence of forming such a structure is as follows:
(1) Removal of third portions of the conductive layer 170, the extrinsic a-Si layer 160, and the intrinsic a-Si layer 150 on the wire areas A;
(2) Removal of the second portions 54 of the photoresist;
(3) Removal of the second portions of the conductive layer 170 and the extrinsic a-Si layer 160 on the channel areas C; and
(4) Removal of the first portions 52 of the photoresist.

Another exemplary sequence is as follows:
(1) Removal of the third portions of the conductive layer 170;
(2) Removal of the second portions 54 of the photoresist;
(3) Removal of the third portions of the extrinsic a-Si layer 160 and the intrinsic a-Si layer 150;
(4) Removal of the second portions of the conductive layer 170;
(5) Removal of the first portions 52 of the photoresist; and
(6) Removal of the second portions of the extrinsic a-Si layer 160.

The first example is described in detail.

As shown in FIGS. 14A and 14B, the exposed third portions of the conductive layer 170 on the remaining areas B are removed by wet etching or dry etching to expose the underlying third portions of the extrinsic a-Si layer 160. An Al-containing metal film is preferably wet etched, while a Mo-containing metal film can be etched both by dry etch and wet etch. The lower and the upper films may be simultaneously etched under the same etching conditions.

Reference numeral 174 indicates portions of the conductive layer 170 including the data lines 171 and the drain electrode 175 connected to each other. The dry etching may etch away the top portions of the photoresist 52 and 54.

Subsequently, the third portions of the extrinsic a-Si layer 160 on the areas B and of the intrinsic a-Si layer 150 are removed preferably by dry etching and the second portions 54 of the photoresist are removed to expose the second portions of the conductors 174. The removal of the second portions 54 of the photoresist are performed either simultaneously with or independent from the removal of the third portions of the extrinsic a-Si layer 160 and of the intrinsic a-Si layer 150. Any residue of the second portions 54 of the photoresist remaining on the channel areas C may be removed by ashing.

The semiconductor stripes 151 are completed in this step, and reference numeral 164 indicates portions of the extrinsic a-Si layer 160 including the ohmic contact stripes and islands 161 and 165 connected to each other, which are called “extrinsic semiconductor stripes.”

The lower film 701 of the conductive layer 170, the extrinsic a-Si layer 160, and the intrinsic a-Si layer 150 are dry-etched in sequence to simplify the manufacturing process. In this case, the dry etching of the three film layers 701, 160, and 150 may be performed in-situ in a single etching chamber.

As shown in FIGS. 15, 16A, and 16B, the second portions of the conductors 174 and the extrinsic a-Si stripes 164 on the channel areas C as well as the first portion 52 of the photoresist are removed.

As shown in FIG. 16B, top portions of the projections 154 of the intrinsic semiconductor stripes 151 on the channel areas C may be removed to cause thickness reduction, and the first portions 52 of the photoresist are etched to a predetermined thickness.

In this way, each conductor 174 is divided into a data line 171 and a plurality of drain electrodes 175 to be completed, and each extrinsic semiconductor stripe 164 is divided into an ohmic contact stripe 161 and a plurality of ohmic contact islands 165 to be completed.

Referring to FIGS. 17, 18A, and 18B, a passivation layer 180 made of silicon nitride or silicon oxide is deposited and photosensitive organic films respectively containing red, green, and blue pigments are coated thereon and patterned by photolithography to form a plurality of color filter stripes 230R, 230G, and 230B in a sequential manner, which have a plurality of apertures or openings 235 exposing portions of the passivation layer 180 that are disposed on the drain electrodes 175.

Referring to FIGS. 19, 20A, and 20B, a photoresist PR is coated on the color filter stripes 230R, 230G, and 230B, and the passivation layer 180 and the gate insulating layer 140 are patterned by etch to form a plurality of contact holes 181, 182, and 185. Any remaining photoresist is then removed.

Finally, as shown in FIGS. 8-10, a plurality of pixel electrodes 190 and a plurality of contact assistants 81 and 82 are formed on the color filter stripes 230R, 230G, and 230B by sputtering and photo-etching an ITO or IZO layer. The etching of the IZO film may include wet etching using a Cr etchant such as HNO₃/(NH₄)₂Ce(NO₃)₆/H₂O, which does not erode the exposed Al portions of the gate lines 121, the data lines 171, and the drain electrodes 175 through the contact holes 181, 182, and 185.

Since the manufacturing method of the TFT array panel according to one embodiment simultaneously forms the data lines 171, the drain electrodes 175, the semiconductor stripes 151, and the ohmic contacts 161 and 165 using one photolithography process, the manufacturing process is simplified by omitting a photolithography step.

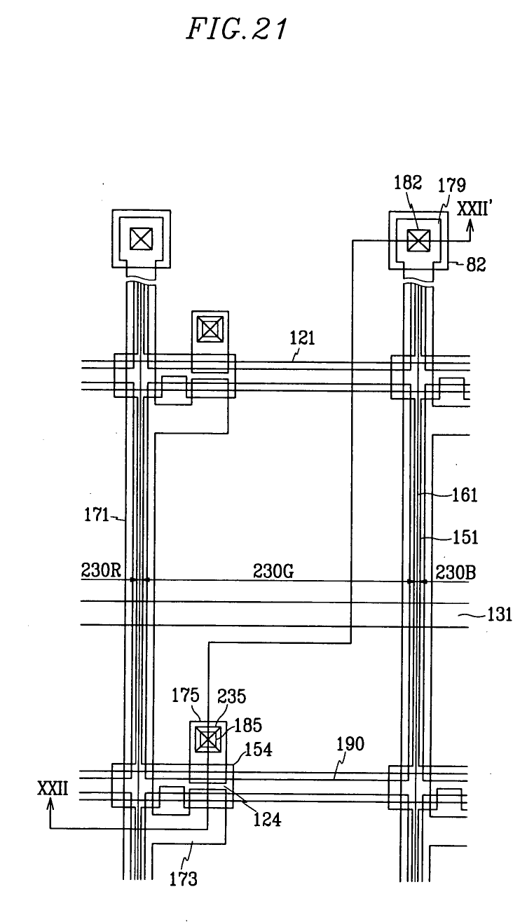

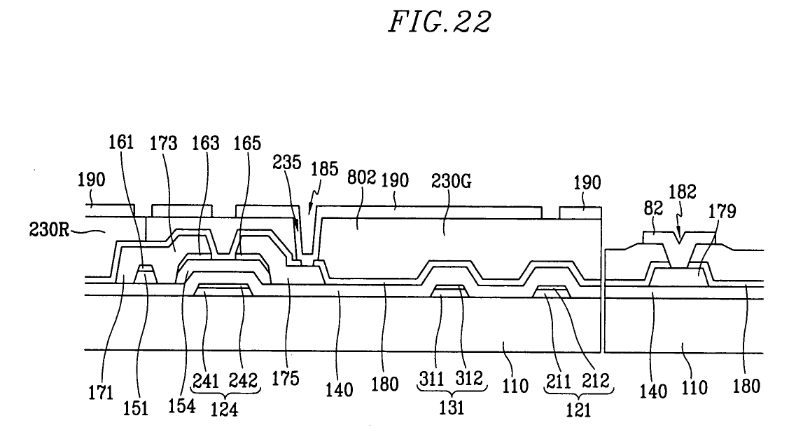

A TFT array panel for an LCD according to another embodiment of the present invention will be described in detail with reference to FIGS. 21 and 22.

FIG. 21 is a layout view of a TFT array panel for an LCD according to another embodiment of the present invention, and FIG. 22 is a sectional view of the TFT array panel shown in FIG. 21 taken along the line XXII-XXII′.

Referring to FIGS. 21 and 22, a layered structure of the TFT array panel according to this embodiment is similar to that shown in FIGS. 1 and 2.

That is, a plurality of gate lines 121 including a plurality of gate electrodes 124 are formed on a substrate 110, and a gate insulating layer 140, a plurality of semiconductor stripes 151 including a plurality of projections 154, and a plurality of ohmic contact stripes 161 including a plurality of projections 163 and a plurality of ohmic contact islands 165, are sequentially formed thereon. A plurality of data lines 171 including a plurality of source electrodes 173 and a plurality of drain electrodes 175 including expansions are formed on the ohmic contacts 161 and 165, respectively, and a passivation layer 180 (that corresponds to the first passivation layer 801 shown in FIG. 2) and a plurality of color filter stripes 230R, 230G, and 230B are formed thereon. A plurality of contact holes 182 and 185 are provided at the passivation layer 180 and a plurality of openings 235 are provided at the color filter stripes 230R, 230G, and 230B. A plurality of pixel electrodes 190 and a plurality of contact assistants 82 are formed on the color filter stripes 230R, 230G, and 230B.

Different from the TFT array panel shown in FIGS. 1 and 2, the TFT array panel according to this embodiment provides a plurality of storage electrode lines 131 on the same layer as the gate lines 121 but separated from the gate lines 121. The storage electrode lines 131 are supplied with a predetermined voltage such as the common voltage and overlap with the pixel electrodes 190 to form storage capacitors. Instead, the storage capacitor conductors 177 as well as the contact holes 187 and the openings 237 shown in FIGS. 1 and 2 are omitted. The storage electrode lines 131 may be omitted if the storage capacitance generated by the overlap of the gate lines 121 and the pixel electrodes 190 is sufficient.

Furthermore, there is no additional passivation layer on the color filter stripes 230R, 230G, and 230B, and thus the pixel electrodes 190 contact a top surface of the color filter stripes 230R, 230G, and 230B and sidewalls of the openings 235 of the color filter stripes 230R, 230G, and 230B as well as the contact holes 185 of the passivation layer 180 such that the pixel electrodes 190 have stepped profiles since the openings 235 are larger than the contact holes 185.

The semiconductor stripes 151 have almost the same planar shapes as the data lines 171 and the drain electrodes 175 as well as the underlying ohmic contacts 161 and 165. However, the projections 154 of the semiconductor stripes 151 include some exposed portions, which are not covered with the data lines 171 and the drain electrodes 175, such as portions located between the source electrodes 173 and the drain electrodes 175.

Many of the above-described features of the TFT array panel for an LCD shown in FIGS. 1 and 2 may be appropriate to the TFT array panel shown in FIGS. 21 and 22.

While the present invention has been described in detail with reference to the aforementioned embodiments, those skilled in the art will appreciate that various modifications and substitutions can be made thereto without departing from the spirit and scope of the present invention as set forth in the appended claims.

1. A thin film transistor array panel, comprising:
an insulating substrate;
a conductive layer over the insulating substrate;
a first passivation layer over the conductive layer;
a color filter over the first passivation layer, the color filter including a color filter aperture;
a second passivation layer over the color filter and filling the color filter aperture; and
a pixel electrode over the second passivation layer, the pixel electrode being operably coupled to the conductive layer via an aperture through the second passivation layer and the first passivation layer, the aperture being aligned with the color filter aperture.

2. The panel of claim 1, wherein the insulating substrate comprises transparent glass.

3. The panel of claim 1, wherein the conductive layer is a drain electrode of a transistor.

4. The panel of claim 1, wherein the conductive layer is a storage capacitor conductor.

5. The panel of claim 1, wherein the conductive layer is comprised of material selected from the group consisting of Al, Mo, Cr, and alloys thereof.

6. The panel of claim 1, wherein the color filter is selected from the group consisting of a blue color stripe, a red color stripe, and a green color stripe.

7. The panel of claim 1, wherein the pixel electrode is comprised of a transparent conductive material selected from the group consisting of indium tin oxide and indium zinc oxide.

8. The panel of claim 1, wherein the aperture through the first and the second passivation layer has a smaller width than the color filter aperture.

9. The panel of claim 3, further comprising a storage electrode line under the pixel electrode and not overlapping with the drain electrode.

10. A thin film transistor array panel, comprising:
an insulating substrate;
a stack with a common etched edge over the insulating substrate, the stack including a semiconductor stripe, an ohmic contact over the semiconductor stripe, and a drain electrode of a transistor over the ohmic contact;
a passivation layer over the stack, the passivation layer having a passivation layer aperture over the stack;
a color filter over the passivation layer, the color filter having a color filter aperture over the stack; and
a pixel electrode over the color filter, the pixel electrode operably coupled to the drain electrode via the color filter aperture and the passivation layer aperture.

11. The panel of claim 10, wherein the insulating substrate comprises transparent glass.

12. The panel of claim 10, wherein the pixel electrode is comprised of a transparent conductive material selected from the group consisting of indium tin oxide and indium zinc oxide.

13. The panel of claim 10, wherein the color filter is selected from the group consisting of a blue color stripe, a red color stripe, and a green color stripe.

14. The panel of claim 10, wherein the passivation layer aperture is aligned with the color filter aperture.

15. The panel of claim 10, wherein the passivation layer aperture has a smaller width than the color filter aperture.

16. The panel of claim 10, further comprising a storage electrode line under the stack.

17. A method of manufacturing a thin film transistor array panel, comprising:
providing an insulating substrate;
forming a conductive layer over the insulating substrate;
forming a first passivation layer over the conductive layer;
forming a color filter over the first passivation layer;
etching a color filter aperture through the color filter and over the conductive layer;
forming a second passivation layer over the color filter and filling the color filter aperture;
etching an aperture through the first and second passivation layers, the aperture being aligned with the color filter aperture; and
operably coupling a pixel electrode to the conductive layer via the aperture through the first and second passivation layers.

18. The method of claim 17, wherein the conductive layer is a drain electrode of a transistor.

19. The method of claim 17, wherein the conductive layer is a storage capacitor conductor.

20. The method of claim 17, wherein the aperture through the first and the second passivation layer has a smaller width than the color filter aperture.

21. The method of claim 17, wherein the first and second passivation layers are simultaneously patterned to etch the aperture.

22. A method of manufacturing a thin film transistor array panel, comprising:
providing an insulating substrate;
forming a stack with a common etched edge over the insulating substrate, the stack including a semiconductor stripe, an ohmic contact over the semiconductor stripe, and a drain electrode of a transistor over the ohmic contact;
forming a passivation layer over the stack;
forming a color filter over the passivation layer;
etching a color filter aperture over the stack;
etching a passivation layer aperture over the stack; and
operably coupling a pixel electrode to the drain electrode via the color filter aperture and the passivation layer aperture.

23. The method of claim 22, wherein the passivation layer aperture has a smaller width than the color filter aperture.

24. The method of claim 22, further comprising providing a photoresist mask over the color filter and the color filter aperture prior to etching the passivation layer aperture.

25. The method of claim 22, further comprising providing a storage electrode line under the stack.
